(19) United States
(12) Patent Application Publication
(10) Pub. No.: US 2005/0216914 A1
(43) Pub. Date: Sep. 29, 2005

(54) Application of the command pattern to a client/server application

(75) Inventors: Brian S. McCain, Tucson, AZ (US); Amy L. Therrien, Tucson, AZ (US)

Correspondence Address: SCULLY, SCOTT, MURPHY, & PRESSER, 400 GARDEN CITY PL, GARDEN CITY, NY, 11530, US

(73) Assignee: International Business Machines Corporation, Armonk, NY (US)

(21) Appl. No.: 10/796,489

(22) Filed: Mar. 5, 2004

(51) Int. Cl. G06F 9/46; G06F 15/16

(52) U.S. Cl. 718/106; 718/102; 709/201

(57) ABSTRACT

A technique for facilitating communication between a client and server using the command pattern. The command pattern is an object-oriented design pattern that describes a pattern for encapsulating instructions and data into a single object, called a command. A client host uses the command pattern to encapsulate instructions and first data into a command object, and provides the command object to a server host. The server host executes the instructions in the command object to provide second data, based on the first data, in the command object, and returns the command object with the second data to the client host. The server host may provide the command object with a reference to a resource, such as a database, for providing the second data. The command object is a single object. The client host interprets the second data in the returned command object.

### BACKGROUND OF THE INVENTION

1. Field of the Invention

The invention relates generally to the field of data storage in computer systems and, more specifically, to a technique for applying the command pattern to facilitate communication between a client and server.

2. Description of the Related Art

In the standard client/server application design, the client passes first data to the server. The server then interprets the first data, manipulates it to obtain second data, and returns the second data back to the client. The client then interprets that second data. However, this requires all the logic for interpreting and manipulating data to be contained within the server, making the server less flexible when trying to change its functionality. Moreover, the server must also know about all types and versions of clients that can connect to it so it can properly handle the data in ways the different clients will understand. Furthermore, if a new client type is added, the server must be updated by a software update to support the client, and old servers cannot support the new client if they cannot be updated, e.g., due to hardware limitations such as processor speed and memory capacity.

### BRIEF SUMMARY OF THE INVENTION

To address these and other issues, the present invention describes a technique for facilitating communication between a client and server using the command pattern.

In a particular aspect of the invention, a method for use by a client host in providing a networked application with a server host includes using a command pattern to encapsulate instructions and first data into a command object, and providing the command object to the server host, wherein the server host executes the instructions in the command object to provide second data, based on the first data, in the command object, and returns the command object with the second data to the client host.

A corresponding program storage device is also provided

In another aspect of the invention, a method is provided for use by a server host in providing a networked application with a client host. The method includes receiving a command object from the client host, wherein a command pattern is used by the client host to encapsulate instructions and first data into the command object, executing the instructions in the command object to provide second data, based on the first data, in the command object, and returning the command object with the second data to the client host.

### BRIEF DESCRIPTION OF THE DRAWINGS

These and other features, benefits and advantages of the present invention will become apparent by reference to the following text and figures, with like reference numbers referring to like structures across the views, wherein:

FIG. 1 illustrates a client host and a server host in a computer system; and

FIG. 2 illustrates a method for applying the command pattern to a client/server application.

### DETAILED DESCRIPTION OF THE INVENTION

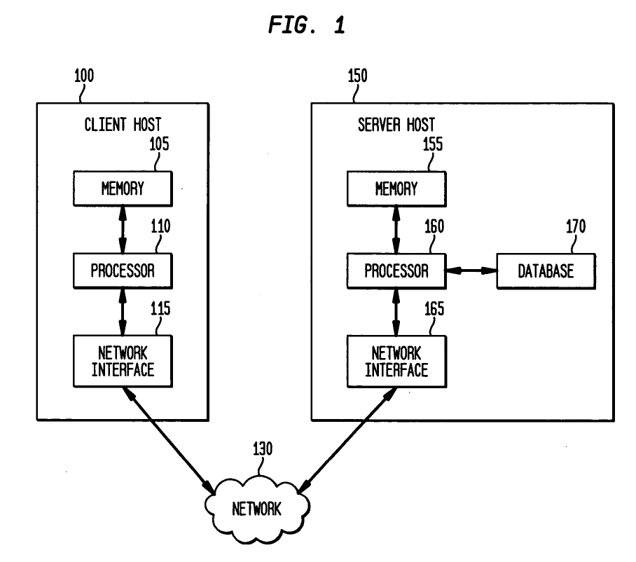

FIG. 1 illustrates a client host 100 and a server host 150 in a computer system. The client host 100 includes a processor 110, memory 105 and network interface 115, while the server host 150 similarly includes a processor 160, memory 155 and network interface 165. The server host 150 may also include a resource such as a database 170 that may be used as discussed further below. The network interfaces 115 and 165 communicate with one another via a network 130 such as the Internet. For example, the client host 100 may implement a client-side of a distributed or networked application, while the server host 150 may implement a server-side of the application.

The general operation and configuration of the processors 110, 160, memories 105, 155, network interfaces 115, 165, and database 170, is well known in the art and is therefore not described in detail. The components illustrated are provided to assist in understanding the invention. The hosts 100, 150 may be general-purpose computers, workstations, servers, portable devices such as PDAs, or other computer devices. The functionality described herein can be achieved by configuring the hosts 100 and 150 with appropriate software. In one approach, the software comprises an object-oriented software such as Java code that is stored in the memories 105, 155. In this case, the memories 105, 155 are program storage devices. The software is executed using the processors 110, 160 in a known manner.

The invention solves the problem described at the outset by applying the command pattern to the client/server application. The command pattern is an object-oriented design pattern that describes a pattern for encapsulating instructions and data into a single object, called a command. A command can be passed around to different components of a software application, and then executed as needed. Components that receive a command can execute the command without knowledge of the data or the purpose of the command. The command pattern may be applied in a graphical user interface (GUI), for instance. For example, an application might request a user to input their address information as first data at a client host. The application presents a window containing fields for the user to input, such as name, address, state, etc. Once the user has input the data, the user presses a submit button to submit the data. In this application, the command pattern could be used to store that first data. When the submit button is pressed, a submit command would be created. The data input by the user would be placed in the submit command, then the submit command would be sent to another part of the software, such as at a server host, for processing. The other software starts the execution of the command, providing the necessary resources, such as access to a database, for this example. The command then executes its instructions, using the data supplied from the user and the resources provided by the software.

The benefit is that a different command, say a command to retrieve data from the database, can be executed by the same piece of software that provides access to the database. This can be achieved by sending a command object from the client to the server, instead of just raw data. The command object contains data, as well as the instructions to process the data. When the server receives the command object from the client, it simply executes the command instructions, then returns the command itself back to the client with new data. This encapsulates the new data within the command, and the client can then find the appropriate data for the command it sent. Advantageously, platform-specific instructions need not be used.

Moreover, the server does not need to know anything about the raw data it receives from the client. If a new client type is added, the server does not need modification since the client will still be sending commands that the server can execute. If the data being sent to the server needs to be changed for any reason, the server does not need to be updated to support the new data. The invention allows for flexibility in the client/server application by allowing new client types and versions to be added that can still communicate with old servers. This can be understood by noting that a command is an abstract data type, in this case, an object. The server knows how to process commands, in the abstract sense. It receives a command, executes it (passing any necessary resources in), then sends the command back. A new command could be created that the server never saw before, yet the server could still handle it and process it, even if the server does not know anything about the clients.

A practical example of using the command pattern in a client/server application is in the context of a company phone book application. The application could be a piece of client software that resides on an employee's computer as the client. When an employee wishes to lookup a phone number of a colleague, the employee enters the colleague's name into the local client application. The application then creates a command object with instructions such as “obtain the phone number of an employee”, and first data such as the employee's name. The application sends the command object as a request to a centralized database server, which contains all employee phone numbers. The colleague's number is found and returned to the employee making the request. In particular, the server executes the instruction “obtain the phone number of an employee” and processes the first data in the command object to look up the employee's phone number based on the employee's name in the database 170. The server thus processes the first data based on the instructions to provide second data, e.g., the employee's phone number. The employee's phone number is included in the command object and returned to the client. The client then interprets and processes the second data in the returned command object, e.g., by displaying the employee's phone number on a display.

In this example, there are two pieces of software. One is the client application, which allows for user input and displays results, and the other is the server database software, which accepts requests, looks up the information, and sends the results back.

Example pseudo code for this application (using Java syntax) would be as follows:

The first file would define the Command from a high level. The interface Command could be as follows:

public interface Command
{

public void execute(DatabaseRef dbRef);

}

Specific command objects are required to do specific actions. In this case, we are doing a lookup, so we could have a lookup command as follows:

public class LookupCommand implements Command
{

private String lookupName;
private String phoneNumber;
/**

```
  * pass in the name to lookup when creating the object
  */
public LookupCommand(String name)
{
```

lookupName = name;

```
}
/**
  *execution method, defined in interface.
  */
public void execute(DatabaseRef dbRef)
{
```

phoneNumber = dbRef.lookup(lookupName);

```
}
/**
  *method for retrieving results of lookup.
  */
public String getPhoneNumber( )
{
```

return phoneNumber;

}

}

The server software to process the command could be as follows:

public class Server
{

public static void main(String[] args)
{

DatabaseRef dbRef = Database.getRef( );
ObjectInputStream connection = acceptConnection( );
ObjectOutputStream output = getOutputStream( );
Command com = null;
while((com = (Command)connection.readObject)( )!=null)
{

com.execute(dbRef);
output.writeObject(com);

}

}

}

The client software could be as follows:

public class Client
{

```
/**
  *args[0] is the name of the person to look up.
  */
public static void main(String[] args)
{
```

ObjectOutputStream output = establishConnection( );
ObjectInputStream input = getInputStream( );
LookupCommand lc = new LookupCommand(args[0]);
output.writeObject(lc);
lc = input.readObject( );
System.out.println(lc.getPhoneNumber( ));

}

}

Now, assume that the company wants to allow its employees to update their own phone numbers in the database. They could release second client software for doing updates. In order to do updates, a new command would be needed, as follows:

public class UpdateCommand implements Command

{

```
private String name;
private String phoneNumber;
private boolean success;
/**
  * create command with the update data
  */
public UpdateCommand(String name, String phoneNumber)
{
```

this.name = name;
this.phoneNumber = phoneNumber;

```
}
/**
  *execute method defined in Command
  */
  public void execute(DatabaseRef dbRef)
  {
```

success = dbRef.update(name, phoneNumber);

```
  }
  public boolean isSuccessful( )
  {
return success;
```

}

}

A new client application could be written as follows:

public class Client2

{

```
/**
  *args[0] is the name of the person to update.
  *args[1] is the new phone number
  */
public static void main(String[ ] args)
{
```

ObjectOutputStream output = establishConnection( );
ObjectInputStream input = getInputStream( );
UpdateCommand uc = new UpdateCommand(args[0],

args[1]);

output.writeObject(uc);
uc = input.readObject( );
System.out.println(“update successful? ” +

uc.isSuccessful( ));

}

}

This new command could be supported by the server without requiring any code changes to the server. And, the same server can be used by both client types without needing to differentiate between them.

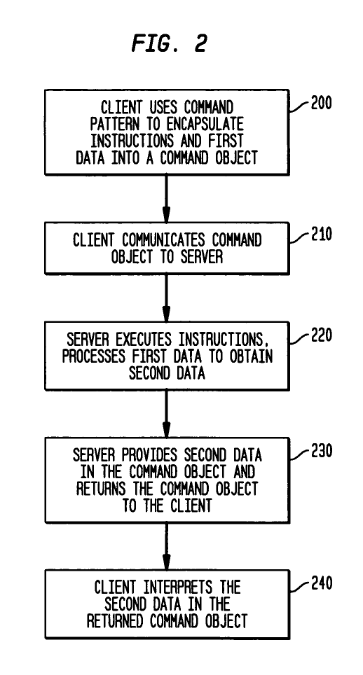

FIG. 2 illustrates a method for applying the command pattern to a client/server application. At block 200, a client uses the command pattern to encapsulate instructions and first data into a command object. At block 210, the client communicates the command object to the server. At block 220, the server executes the instructions, and processes the first data according to the instructions to obtain second data. A resource such as a database may be used for this purpose. At block 230, the server provides the second data in the command object and returns the command object to the client. At block 240, the client interprets the second data in the returned command object.

The invention has been described herein with reference to particular exemplary embodiments. Certain alterations and modifications may be apparent to those skilled in the art, without departing from the scope of the invention. The exemplary embodiments are meant to be illustrative, not limiting of the scope of the invention, which is defined by the appended claims.

1. A method for use by a client host in providing a networked application with a server host comprising:
using a command pattern to encapsulate instructions and first data into a command object; and
providing the command object to the server host;
wherein the server host executes the instructions in the command object to provide second data, based on the first data, in the command object, and returns the command object with the second data to the client host.

2. The method of claim 1, wherein:
the second data provides a reference to a resource.

3. The method of claim 2, wherein:
the resource comprises a database.

4. The method of claim 1, wherein:
the command object is a single object.

5. The method of claim 1, further comprising:
interpreting the second data in the returned command object.

6. The method of claim 1, wherein:
the instructions include instructions for processing the first data to obtain the second data.

7. A program storage device tangibly embodying a program of instructions executable by a machine to perform a method for use by a client host in providing a networked application with a server host, the method comprising:
using a command pattern to encapsulate instructions and first data into a command object; and
providing the command object to the server host;
wherein the server host executes the instructions in the command object to provide second data, based on the first data, in the command object, and returns the command object with the second data to the client host.

8. The program storage device of claim 7, wherein:
the second data provides reference to a resource.

9. The program storage device of claim 8, wherein:
the resource comprises a database.

10. The program storage device of claim 7, wherein:
the command object is a single object.

11. The program storage device of claim 7, wherein the method further comprises:
interpreting the second data in the returned command object.

12. The program storage device of claim 7, wherein:
the instructions include instructions for processing the first data to obtain the second data.

13. A method for use by a server host in providing a networked application with a client host, comprising:
receiving a command object from the client host;
wherein a command pattern is used by the client host to encapsulate instructions and first data into the command object;
executing the instructions in the command object to provide second data, based on the first data, in the command object; and
returning the command object with the second data to the client host.

14. The method of claim 13, wherein:
the second data provides a reference to a resource.

15. The method of claim 14, wherein:
the resource comprises a database

16. The method of claim 13, wherein:
the command object is a single object

17. The method of claim 13, wherein:
the client host interprets the second data in the returned command object.

18. The method of claim 13, wherein:
the instructions include instructions for processing the first data to obtain the second data.
